(19) United States
(12) Patent Application Publication
(10) Pub. No.: US 2014/0017370 A1
(43) Pub. Date: Jan. 16, 2014

(54) FROZEN UNCOOKED FISH MEAT PRODUCT AND METHOD FOR PRODUCING SAME

(71) Applicants: Takayuki Ishida, Tokyo (JP); Mitsutoshi Kubota, Tokyo (JP)

(72) Inventors: Takayuki Ishida, Tokyo (JP); Mitsutoshi Kubota, Tokyo (JP)

(73) Assignee: NIPPON SUISAN KAISHA, LTD., Tokyo (JP)

(21) Appl. No.: 14/007,542

(22) PCT Filed: Mar. 21, 2012
(86) PCT No.: PCT/JP2012/057195

§ 371 Date: Sep. 25, 2013

(30) Foreign Application Priority Data
Mar. 28, 2011 (JP) 2011-070527

(51) Int. Cl. A23B 4/20

(52) U.S. Cl. CPC A23B 4/20
USPC 426/332; 426/643

(57) ABSTRACT

Problem: The problem of the present invention is to provide a frozen unwashed minced fish meat that has high versatility similar to that of frozen surimi and that is capable of frozen storage. In particular, the problem of the present invention is to prevent the freezing-denaturation of frozen unwashed minced fish meat of a fish of the order Gadiformes that is widely used for frozen surimi.

Means to Solve the Problem: A frozen uncooked fish meat product in which an alcohol having from 2 to 5 carbons and capable of being used in foodstuffs is added. Preferably, to the frozen uncooked fish meat product, sugars or sugar alcohols and/or salts are further added. A method for preventing freezing-denaturation of uncooked fish meat, the method comprising suppressing freezing-denaturation due to trimethylamine-N-oxide degradation by adding an alcohol having from 2 to 5 carbons that is capable of being used in foodstuffs to the uncooked fish meat.

### TECHNICAL FIELD

The present invention relates to a method for prevention of denaturation that results from freezing of fish meat. In particular, the present invention relates to a frozen uncooked fish meat product in which there is suppression of the lowering of quality caused by degradation of trimethylamine-N-oxide (referred to hereinafter as TMAO), which progresses during frozen storage of fish meat, and the present invention relates to a production method for the frozen uncooked fish meat product.

### BACKGROUND ART

The production of surimi (water-washed minced fish meat) from fish meat has become a global industry that operates throughout the world. In recent years, however, surimi containing previously unused raw materials has been produced for reasons such as fishing restrictions and effective use of resources.

The basic principles of surimi production are as follows. After removing the head and internal organs from the raw fish, butterflied fillets, or deboned fillets are prepared. Thereafter, the fillets are placed in a meat separator, and a minced fish meat (i.e. Otoshimi, unwashed minced fish meat) is recovered. Water-soluble proteins, which inhibit the formation of gels, are removed from the proteins of this fish meat by soaking in water, skin, sinew, and bones are removed with a refiner, the fish meat is dehydrated and the myofibrillar proteins, which are the main gel forming proteins, are condensed. This dehydrated meat is blended with a freezing-denaturation preventing agent such as a sugar, a sugar alcohol and a polyphosphate and then frozen.

During the production of frozen surimi, most water-soluble proteins are removed during the water leaching step and dehydrating step, even though such proteins should form the basis of nutrition and flavor. From the standpoints of the effective use of resources and decreasing the amount of waste, it would of course be more preferable to use unwashed minced fish meat without water leaching. However, the utilization of frozen unwashed minced fish meat is limited compared to the frozen surimi because the surimi has increased frozen storage ability and broader versatility.

Quality of the unwashed minced fish meat of white-fleshed fish, such as members of the order Gadiformes, is evaluated by smell, texture, or the like. The TMAO contained in the white-fleshed fish degrades to generate dimethylamine (referred to hereinafter as DMA) and formaldehyde (referred to hereinafter as FA). DMA is the substance that causes unpleasant fish odor. FA works as a denaturation agent for proteins. FA is thought to be one cause for lowering of the gel-forming ability of fish meat and hardening of texture.

Based on technology for frozen surimi that performs freezing after removal of TMAO mainly by water leaching, fish species in which TMAO degradation progresses, such as members of the order Gadiformes or the like, are being used in large amounts as a raw material that has high versatility. However, the use of frozen unwashed minced fish meat is limited due to the progress of degradation of TMAO and lowering of gel-forming ability since the unwashed minced fish meat is not subjected to water leaching, and frozen unwashed minced fish meat is not often used as a raw material for fish paste products.

Although a method of oxidizing fish meat is reported as a technique for the suppression of the degradation of TMAO, a 5 to 30 minute stirring step using a silent cutter is required, and this method cannot be said to have high productivity (Patent Document 1).

Although alcohol in the form of rice wine or sweet cooking rice wine is sometimes used during cooking of fish meat, there is no active use of alcohol during frozen storage of uncooked fish meat. Patent Document 2 discloses a modification agent for a frozen surimi and fish paste product containing protamine, a surfactant, and an alcohol. However, the alcohol is used as an aid for increasing uniform dispersion of the protamine. Moreover, Patent Document 3 discloses frozen surimi to which has been added 1 to 6 parts of ethanol per 100 parts of fish meat, although the object is to produce a frozen surimi that has a low bacterial count. Patent Document 4 contains mention of a production method that treats protease-treated unwashed minced fish meat using ethanol and an alkaline substance under vacuum, but this production method is unrelated to freezing-denaturation.

### BACKGROUND ART DOCUMENTS

### Patent Documents

Patent Document 1: Japanese Patent No. 4404345

Patent Document 2: Japanese Unexamined Patent Application Publication No. H1-262777

Patent Document 3: Japanese Unexamined Patent Application Publication No. S51-86163

Patent Document 4: Japanese Patent No. 3831850

### SUMMARY OF THE INVENTION

### Problems to be Solved by the Invention

The problem of the present invention is to provide a frozen unwashed minced fish meat that has high versatility similar to that of frozen surimi and that is capable of frozen storage. In particular, the problem of the present invention is to prevent the freezing-denaturation of frozen unwashed minced fish meat of a fish of the order Gadiformes that is widely used for frozen surimi.

### Means for Solving the Problems

The present invention was achieved by discovery of the ability to suppress the degradation of TMAO by addition to fish meat of alcohol, in addition to sugar or a sugar alcohol, as freezing-denaturation preventing agents. By the simple method of just adding an alcohol, such as ethanol and the like alcohols widely used for food applications, it becomes possible to produce a frozen unwashed minced fish meat that retains gel-forming ability so as to be capable of being used as the raw material for a fish paste product.

The gist of the present invention is the frozen uncooked fish meat product of the (1) to (8) below, and the method for preventing freezing-denaturation of an uncooked fish meat, the frozen uncooked fish meat product, and the processed food of the (9) to (16) below.

(1) A frozen uncooked fish meat product wherein an alcohol having from 2 to 5 carbons that is capable of being used in foodstuffs is added.

(2) The frozen uncooked fish meat product of (1); wherein an added amount of the alcohol is 0.05 to 5.0% by weight relative to the fish meat.

(3) The frozen uncooked fish meat product of (1); wherein an added amount of the alcohol is 0.2 to 1.0% by weight relative to the fish meat.

(4) The frozen uncooked fish meat product of any one of (1) to (3); which further comprises a sugar or a sugar alcohol, and/or a salt.

(5) The frozen uncooked fish meat product of any one of (1) to (4); wherein the fish meat is a fish meat comprising trimethylamine-N-oxide.

(6) The frozen uncooked fish meat product of (5); wherein the fish meat is a fish meat of a member of the order Gadiformes.

(7) The frozen uncooked fish meat product of any one of (1) to (6); wherein the fish meat is at least one type selected from an unwashed minced fish meat, a fillet, and a fillet block.

(8) The frozen uncooked fish meat product of any one of (1) to (7); wherein the alcohol having from 2 to 5 carbons is ethanol or a food material comprising ethanol.

(9) A method for preventing freezing-denaturation of uncooked fish meat, the method comprising adding an alcohol having from 2 to 5 carbons that is capable of being used in foodstuffs to an uncooked fish meat to thereby suppressing freezing-denaturation.

(10) The method for preventing freezing-denaturation of (9); wherein the freezing-denaturation is due to degradation of trimethylamine-N-oxide included in the fish meat.

(11) The method for preventing freezing-denaturation of (9) or (10); which further comprises adding a sugar or a sugar alcohol, and/or a salt.

(12) The method for preventing freezing-denaturation of any one of (9) to (11); wherein the fish meat is at least one type selected from a surimi, an unwashed minced fish meat, a fillet, and a fillet block.

(13) The method for preventing freezing-denaturation of any one of (9) to (12); wherein the alcohol having from 2 to 5 carbons is ethanol or a food material comprising ethanol.

(14) The method for preventing freezing-denaturation of uncooked fish meat of any one of (9) to (13); wherein an added amount of the alcohol is 0.05 to 5.0% by weight relative to the fish meat.

(15) A frozen uncooked fish meat product that has been treated by the method of any one of (9) to (14).

(16) A fish meat processed food product produced by utilizing the frozen uncooked fish meat product according to (15) as a raw material.

### Advantage of the Invention

TMAO included in the fish meat of an unwashed minced fish meat in frozen storage degrades to become DMA, FA, or the like, and this causes a lowering of quality, such as a worsening of the gel-forming ability of fish meat, and the like. According to the method of the present invention, by the addition of an alcohol such as ethanol or the like together with other freezing-denaturation preventing agents (such as sugars, sugar alcohols, or the like) before freezing, it is possible to prevent the degradation of TMAO, and it is possible to prevent freezing-denaturation of fish meat.

### MODE FOR CARRYING OUT THE INVENTION

By the addition of an alcohol, the present invention prevents denaturation of fish meat by suppressing degradation of the trimethylamine-N-oxide contained in the fish meat.

The term “alcohol” in the present invention refers to an alcohol having from 2 to 5 carbons, and specific examples include ethanol, propanol, butanol, and pentanol. Among these alcohols, an alcohol that is recognized to be usable for foodstuffs may be used. Ethanol, which is widely used in foodstuffs in practice, is preferably used.

Ethanol of 100% purity may be used as the ethanol. Alternatively, a diluted ethanol, or an ethanol-containing foodstuff may be used, such as a liquor or fermented seasoning. Such ethanol-containing foodstuffs are exemplified by liquors such as wines, refined rice wines, distilled spirits, Chinese rice wines, sweet cooking rice wines, brandies, rums, liqueurs, whiskies, and the like; and sweet cooking rice wine-type fermented seasonings, wine-type fermented seasonings, distilled spirit-type fermented seasonings, and the like. Ethanol-containing foodstuffs having an alcohol content of about 10 to 50% are readily used.

The added amount of the alcohol is 0.05 to 5.0% by weight relative to the moist weight of the fish meat, and preferably is 0.2 to 1.0% by weight. When an alcohol-containing foodstuff is used, the amount of foodstuff that may be added, expressed as the amount of alcohol, is within these ranges.

In the present invention, the expression “uncooked fish meat” refers to fish meat that is fresh and has not been heated to a temperature above the temperature where proteins would be denatured by heat cooking or the like (around 60° C.). That is to say, “uncooked fish meat” means fish meat that has had a thermal history of room temperature or below. That is to say, this uncooked fish meat is a raw material prior to processing, such as fresh fish meat with attached bones and skin, fillets that have had bones and skin removed, cut fillet block raw material, unwashed minced fish meat, and the like. Prior to freezing storage of these uncooked fish meats, an alcohol is added together with other freezing-denaturation preventing agents.

In the case of unwashed minced fish meat, these components may be added by blending and mixing. In the case of other types of fish meats, a known method may be used for instilling a liquid component, such as soaking, injection, vacuum soaking, and the like, so that these components are instilled into the center of the fish meat.

The term “unwashed minced fish meat” in the present invention is fish meat that has been obtained in the form of mince, although water leaching has not been performed in order to remove water-soluble protein, as would be performed for surimi. The term “fillet” refers to fish meat that has simply had the bones and skin removed. The expression “fillet block” refers to a foodstuff obtained by freezing fillets, flakes thereof, or the like in an unsorted (by size and shape) manner in a mold. By cutting and using such fillet blocks, it is possible to produce a product that has a fixed size and shape.

The fish meat that is the subject of the invention may be that of any species of fish that has fish meat that includes TMAO and that degrades into DMA and FA in frozen storage. Specifically, fish of the order Gadiformes (e.g. Alaska pollock (Theragra chalcogramma) and southern blue whiting (Micromesistius australis), which belong to the family Gadidae and the order Gadiformes, patagonian grenadier (Macruronus magellanicus), which belongs to the family Macruronidae and order Gadiformes, or the like), lizardfish species (e.g. lizardfish genus (Saurida sp.) belonging to the family Synodontidae and the order Aulopiformes, or the like) contain a high amount of TMAO in the fish meat, and the TMAO is known to degrade during frozen storage and to lower quality of the fish meat. In particular, it is possible to anticipate a clear effect in fish meat that contains 30 mmol/kg or more of TMAO in the fish meat. Lowering of quality is seen by progressive hardening of meat texture, progressive salt insolubility, unpleasant odor, lowering of gel-formation ability, or the like. When the FA generated by degradation of the TMAO contained in fish meat promotes crosslinking reactions between proteins, hardening of the meat and salt insolubility are caused. When DMA generated in an equimolar amount with the FA due to TMAO degradation, an unpleasant fish odor is generated.

Freezing-denaturation preventing agents that are capable of being used together with alcohols are exemplified by sugars, sugar alcohols, or the like, as well as oxidants or the like known to be useful for suppressing the degradation of TMAO. The use of alcohols together with sugars or sugar alcohols is particularly preferred. The sugars and sugar alcohols are exemplified by sucrose, sorbitol, trehalose, glucose, xylitol, mannitol, xylose, sorbitan, fructose, maltose, or the like. The added amount of the sugar or sugar alcohol relative to fish meat (moist weight) is 1 to 20% by weight, and preferably is 5 to 15% by weight.

It is possible to increase the freezing-denaturation prevention effect by diluting the fish meat by addition of water or a food material. Specifically, the fish meat may be diluted by adding water, oil-fat, soybean protein, starch, various types of extracts, or the like.

Moreover, the addition of a salt and then stirring of the salt-soluble proteins in a dissolved state is effective for the fish meat to be readily oxidized. The added amount of salt relative to 100% fish meat is 0.01 to 5%, and preferably is 0.1 to 3%.

Salts for addition in order to make fish meat readily oxidized are exemplified by sodium chloride, potassium chloride, sodium carbonate, sodium bicarbonate, sodium pyrophosphate, sodium metaphosphate, sodium primary phosphate, sodium secondary phosphate, sodium tertiary phosphate, potassium carbonate, sodium succinate, sodium gluconate, or the like. Sodium chloride may be preferably used.

In the present invention, the expression “freezing-denaturation is suppressed” means there is little denaturation of proteins during freezing storage, i.e. that the change over time of salt solubility of fish meat protein is small, or that the fish meat has gel-forming ability and the change of such gel-forming ability changes little over time. Moreover, this expression indicates that the suppression of the generated amount of substances (DMA and FA) that are normally generated by degradation of TMAO during frozen storage. Specifically, freezing-denaturation suppression may be observed: by the fish meat having gel-forming ability even after 1 month of storage at −20° C., by the generated amounts of DMA and FA from degradation of TMAO each being less than or equal to 3 mmol per kg of fish meat, by the salt solubility (i.e. indicator for degree of non-denaturation of protein) being greater than or equal to 20%, or the like.

Frozen fish meat is normally stored at −20° C. to −25° C. Long-term frozen storage ability was evaluated during a short time interval by frozen storage at −10° C. in the present experiments. By storage under conditions more severe than those of normal storage, i.e. by extreme condition testing, the test method observes storage stability over a short time interval. Using the FA amount as an indicator for comparison, a sample that had been stored for 2 weeks at −10° C. was confirmed to display about the same degree of change as a sample that had been stored for 1 year at −20° C. As shown in the working examples, the frozen fish meat of the present invention was found to be able to be stored for 2 to 4 weeks at −10° C., and thus frozen storage is possible at −20° C. for at least 1 year or more, and for 1 to 2 years.

The fish meat with suppressed freezing-denaturation of the present invention may be used as a raw material for a fish paste product. This fish meat with suppressed freezing-denaturation of the present invention may be used in exactly the same manner as the frozen surimi that is widely used presently as a raw material for fish paste products. Since water-soluble proteins remain that are lost in frozen surimi, the fish meat with suppressed freezing-denaturation of the present invention has a large amount of savoriness flavor components (i.e. umami components), and there is less need for supplementing the savoriness flavor components using sodium glutamate or the like. The fish paste product is exemplified by plain kamaboko, fried kamaboko, boiled kamaboko, chikuwa, imitation crab leg kamaboko, fried fish cake, fish ham, fish sausage, fish cakes, or the like.

Moreover, fillets or fillet blocks may be used as the ingredient for fried products (e.g. fried fish, fish tempura, or the like) or fried-grilled fish (e.g. Meunière or the like).

As explained above, a most preferred embodiment of the present invention is a method that adds to fish meat 0.05 to 5.0% by weight of ethanol, 1 to 20% by weight of sugar or sugar alcohol, and 0.01 to 5% by weight of sodium chloride, then mixes the mixture uniformly, and then freezes and stores the mixture. In a particularly preferred embodiment, 0.2 to 1.0% by weight of ethanol, 5 to 15% by weight of sugar or sugar alcohol, and 0.1 to 3% by weight of sodium chloride are added. When fillets, fillet blocks, or the like are used, the additives may be added by permeation until the additives have reached the center of the fish meat.

The present invention will now be explained in greater detail through the use of working examples, but is in no way limited to these working examples.

### Working Example 1

### TMAO Degradation Suppression Effect of Alcohols

Alaska pollock unwashed minced fish meat was used for evaluation of the TMAO degradation suppression effects of various types of alcohols. Firstly, the head and internal organs were removed from Alaska pollock, and unwashed minced fish meat was produced using a meat separator. Thereafter, 10% sugar was added to the unwashed minced fish meat, and then 1% of a primary alcohol having different numbers of carbons was added (e.g. methanol, ethanol, 1-propanol, 1-butanol, 1-pentanol, or 1-hexanol). After storage for 2 weeks at -10° C., the TMAO degradation suppression effect was evaluated. The TMAO degradation suppression effect was evaluated by measuring the content of DMA generated by degradation of TMAO. That is to say, the DMA content was measured immediately after the start of frozen storage, then DMA content was measured after frozen storage, and a comparison was made of the amount of increase of DMA during frozen storage. DMA was quantitatively determined by the copper-dithiocarbamate method based on the method of Dyer et al. DMA content per 1 kg of fish meat was calculated.

The results are shown in Table 1. Although the DMA content in frozen storage increased by 3.63 mmol/kg for the test section 1 in which only 10% sugar was added, in comparison to this test section in which only 10% sugar was added, the amounts of DMA increase were relatively low for the test sections in which ethanol, 1-propanol, 1-butanol, or 1-pentanol was added, and it was clear that the degradation of TMAO was suppressed in the test sections in which such alcohols were added.

TABLE 1

| | DMA content (mmol/kg of fish meat) | | |
|---|---|---|---|
| | Immediately | After 2 | Increase of |
| | after | weeks storage | amount during |
| Additives | freezing | at −10° C. | frozen storage |
| 10% sugar | 0.84 | 4.47 | 3.63 |
| 10% sugar + | 0.86 | 4.57 | 3.71 |
| 1% methanol | | | |
| 10% sugar + | 0.88 | 1.86 | 0.98 |
| 1% ethanol | | | |
| 10% sugar + | 0.81 | 1.51 | 0.7 |
| 1% 1-propanol | | | |
| 10% sugar + | 0.81 | 1.49 | 0.68 |
| 1% 1-butanol | | | |
| 10% sugar + | 0.91 | 2.18 | 1.27 |
| 1% 1-pentanol | | | |
| 10% sugar + | 0.95 | 4.48 | 3.53 |
| 1% 1-hexanol | | | |

### Working Example 2

### TMAO Degradation Suppression Effect of Ethanol Addition

An unwashed minced fish meat was prepared using Alaska pollock in the same manner as in Working Example 1. Then samples were produced using the additives shown in Table 2. The prepared samples were stored for 2 weeks at −10° C., and then the TMAO degradation suppression effect was evaluated.

As shown in Table 2, the increased amount of DMA content decreased according to the ethanol concentration, and it became clear that the degradation of TAMO was suppressed.

TABLE 2

DMA content (mmol/kg of fish meat)

| | Immediately | After 2 | Increase of |
|---|---|---|---|
| | after | weeks storage | amount during |
| Additives | freezing | at −10° C. | frozen storage |
| 10% sugar | 0.97 | 4.58 | 3.61 |
| 10% sugar + | 0.87 | 2.86 | 1.99 |
| 0.5% ethanol | | | |
| 10% sugar + | 0.88 | 1.86 | 0.98 |
| 1% ethanol | | | |
| 10% sugar + | 0.9 | 1.63 | 0.73 |
| 2% ethanol | | | |

### Working Example 3

### TMAO Degradation Suppression Effect by Combined Use of Sugar, Ethanol, and Salt

An unwashed minced fish meat was prepared using Alaska pollock in the same manner as in Working Example 1. Then samples were produced using the additives shown in Table 3. The prepared samples were stored for 2 weeks at −10° C., and then the TMAO degradation suppression effect was evaluated.

As shown in Table 3, when salt was added in addition to addition of 10% sugar and 0.5% ethanol, the amount of increase of DMA content decreased in a manner dependent on salt concentration, and it became clear that the degradation of TAMO was suppressed.

TABLE 3

| | DMA content (mmol/kg of fish meat) | | |
|---|---|---|---|
| | Immediately | After 2 | Increase of |
| | after | weeks storage | amount during |
| Additives | freezing | at −10° C. | frozen storage |
| 10% sugar + | 0.87 | 2.86 | 1.99 |
| 0.5% ethanol | | | |
| 10% sugar + | 0.86 | 2.23 | 1.37 |
| 0.5% ethanol + | | | |
| 0.3% salt | | | |
| 10% sugar + | 0.85 | 2.13 | 1.28 |
| 0.5% ethanol + | | | |
| 0.6% salt | | | |
| 10% sugar + | 0.84 | 1.85 | 1.01 |
| 0.5% ethanol + | | | |
| 0.9% salt | | | |

### Working Example 4

An unwashed minced fish meat was prepared using Alaska pollock in the same manner as in Working Example 1. Then samples were produced by addition of 10% sugar and 1% salt, and then adding ethanol in the concentration range of 0 to 5%. The prepared samples were stored for 2 weeks at -10° C., and the TMAO degradation suppression effect was evaluated.

As shown in Table 4, when ethanol was added to fish meat in addition to the 10% sugar and 1% salt, the amount of increase of DMA content decreased according to the concentration of ethanol, and it became clear that the degradation of TAMO was suppressed.

TABLE 4

DMA content (mmol/kg of fish meat)

| | Immediately | After 2 | Increase of |
|---|---|---|---|
| | after | weeks storage | amount during |
| Additives | freezing | at −10° C. | frozen storage |
| 10% sugar + | 1.09 | 5.02 | 3.93 |
| 1% salt | | | |
| 10% sugar + | 1.08 | 3.06 | 1.98 |
| 1% salt + | | | |
| 0.1% ethanol | | | |
| 10% sugar + | 1 | 2.36 | 1.36 |
| 1% salt + | | | |
| 0.2% ethanol | | | |
| 10% sugar + | 0.97 | 2.06 | 1.09 |
| 1% salt + | | | |
| 0.3% ethanol | | | |
| 10% sugar + | 0.99 | 1.97 | 0.98 |
| 1% salt + | | | |
| 0.5% ethanol | | | |
| 10% sugar + | 1.03 | 1.99 | 0.96 |
| 1% salt + | | | |
| 1.0% ethanol | | | |
| 10% sugar + | 1.01 | 1.87 | 0.86 |
| 1% salt + | | | |
| 2.5% ethanol | | | |
| 10% sugar + | 0.98 | 1.56 | 0.58 |
| 1% salt + | | | |
| 5.0% ethanol | | | |

### Working Example 5

### Quality After Cooking Unwashed Minced Fish Meat in Which TMAO Degradation was Suppressed

Alaska pollock was used to prepare an unwashed minced fish meat. Then a sample was produced by addition to the fish meat of (1) 10% sugar. A sample was also produced by addition to the fish meat of (2) 10% sugar, 1% salt, and 1% ethanol.

Next, the samples were stored for 4 weeks at −10° C., and then a kamaboko gel was prepared for evaluating quality after heating-cooking. After thawing the unwashed minced fish meat, a food cutter was used to prepare a fish paste meat by performing rough grinding and salt grinding (addition of 3% by weight table salt). Kamaboko was prepared by placing the ground fish meat in a poly(vinylidene chloride) film and heating for 40 minutes at 90° C. Next, the gel strength of the obtained kamaboko was measured. The gel strength was calculated in terms of GS (g·cm) by cutting the above-mentioned kamaboko into rings 2.5 cm thick and then multiplying the breaking strength (W value (g)), which is measured using a plunger having a diameter of 5 mm, by the distance until breaking (L value (cm)). Moreover, the smell of the heated gel was evaluated by sensory testing.

The results are shown in Table 5. Gel strength could not be measured for the heated gel of the unwashed minced fish meat to which 10% sugar had been added, and this sample was confirmed to have an unpleasant fish odor. These phenomena are thought to be due to the progress of the degradation of TMAO. On the other hand, the sample produced by adding 10% sugar, 1% salt, and 1% ethanol to fish meat had gel-formation ability, and no unpleasant fish odor was noticed. This is thought to be due to suppression of the degradation of TMAO by the addition of 1% salt and 1% ethanol.

TABLE 5

| | Gelation strength | | | |
|---|---|---|---|---|
| | W value | L value | GS | Unpleasant |
| Additives | (g) | (cm) | (g · cm) | fish odor |
| 10% sugar | Not able to measure | | | Felt |
| 10% sugar + 1% salt + | 230 | 0.61 | 141 | Not felt |
| 1.0% ethanol | | | | |

### INDUSTRIAL APPLICABILITY

According to the present invention, a frozen unwashed minced fish meat that has high versatility similar to that of frozen surimi and that is capable of frozen storage can be provided.

1. A frozen uncooked fish meat product comprising an uncooked fish meat which contains an alcohol having from 2 to 5 carbons that is capable of being used in foodstuffs.

2. The frozen uncooked fish meat product according to claim 1; wherein an added amount of the alcohol is 0.05 to 5.0% by weight relative to said fish meat.

3. The frozen uncooked fish meat product according to claim 1; wherein an added amount of the alcohol is 0.2 to 1.0% by weight relative to said fish meat.

4. The frozen uncooked fish meat product according to claim 1; which further comprises a sugar or a sugar alcohol, and/or a salt.

5. The frozen uncooked fish meat product according to claim 1; wherein said fish meat is a fish meat comprising trimethylamine-N-oxide.

6. The frozen uncooked fish meat product according to claim 5; wherein said fish meat is a fish meat of a member of the order Gadiformes.

7. The frozen uncooked fish meat product according to claim 1; wherein said fish meat is at least one type selected from an unwashed minced fish meat, a fillet, and a fillet block.

8. The frozen uncooked fish meat product according to claim 1; wherein the alcohol having from 2 to 5 carbons is ethanol or a food material comprising ethanol.

9. A method for preventing freezing-denaturation of uncooked fish meat, the method comprising adding an alcohol having from 2 to 5 carbons that is capable of being used in foodstuffs to an uncooked fish meat to thereby suppressing a freezing-denaturation of the uncooked fish meat.

10. The method for preventing freezing-denaturation according to claim 9;
wherein the freezing-denaturation is due to degradation of trimethylamine-N-oxide included in said fish meat.

11. The method for preventing freezing-denaturation according to claim 9; which further comprises adding a sugar or a sugar alcohol, and/or a salt.

12. The method for preventing freezing-denaturation according to claim 9; wherein said fish meat is at least one type selected from a surimi, an unwashed minced fish meat, a fillet, and a fillet block.

13. The method for preventing freezing-denaturation according to claim 9; wherein the alcohol having from 2 to 5 carbons is ethanol or a food material comprising ethanol.

14. The method for preventing freezing-denaturation of uncooked fish meat according to claim 9; wherein an added amount of the alcohol is 0.05 to 5.0% by weight relative to said fish meat.

15. A frozen uncooked fish meat product that has been treated by the method according to claim 9.

16. A fish meat processed food product produced by utilizing the frozen uncooked fish meat product according to claim 15 as a raw material.
